(19) United States
(12) Patent Application Publication
(10) Pub. No.: US 2006/0217106 A1
(43) Pub. Date: Sep. 28, 2006

(54) Prepaid wireless system and method

(76) Inventors: Gary Davidson, DeSoto, TX (US); Gary Ford, Colleyville, TX (US)

Correspondence Address: CARSTENS & CAHOON, LLP, P O BOX 802334, DALLAS, TX, 75380, US

(21) Appl. No.: 10/552,954

(22) PCT Filed: Apr. 14, 2004
(86) PCT No.: PCT/US04/09284

§ 371 Date: Oct. 14, 2005

Related U.S. Application Data
(60) Provisional application No. 60/462,661, filed on Apr. 14, 2003.
(60) Provisional application No. 60/472,681, filed on May 22, 2003.

(51) Int. Cl. H04M 11/00

(52) U.S. Cl. 455/405; 455/558; 455/418

(57) ABSTRACT

A system and method for providing prepaid wireless services. One embodiment includes a mobile unit configured to maintain an amount of time units for which the mobile unit is authorized to utilize wireless services. The amount of time units is preferably prepaid for by the customer. The mobile unit prevents utilization of wireless services upon the expiration of the amount of prepaid time units. Furthermore, it is preferred that a prepaid application server receive notification from the wireless service provider of the use of time units by the mobile unit. In this manner, the prepaid application server may monitor the availability of time units and prevent fraudulent use when the amount of prepaid time units expire.

This application claims the priority benefit of commonly owned U.S. Provisional Patent Application having Ser. No. 60/462,661 entitled PREPAID WIRELESS SYSTEM AND METHOD filed on Apr. 14, 2003, which is hereby incorporated by reference.

This application claims the priority benefit of commonly owned U.S. Provisional Patent Application having Ser. No. 60/472,681 entitled PREPAID WIRELESS SYSTEM AND METHOD filed on May 22, 2003, which is hereby incorporated by reference.

### TECHNICAL FIELD

The present invention relates generally to telecommunications and, more particularly, to a system and method for providing prepaid wireless services.

### BACKGROUND

Wireless service providers provide communications services between a mobile unit, such as a wireless phone, PDA, computer, or the like, and another user. Generally, the mobile unit communicates with a wireless network via a wireless communications protocol such as CDMA, TDMA, GSM, GPRS, or the like. The wireless network in turn provides connectivity to the telecommunications network, which typically comprises switches interconnected by cables or fiber and provides communications services to the other user.

As the proliferation of wireless services have grown, so to has the types of service offerings expanded to reach different market segments and to grow market share of existing market segments. One sector of the population that wireless service providers have attempted to tap is the low-income or high-credit risk individuals. Generally, wireless services are more expensive than the typical landline telephone. As a result, low-income or high-credit risk individuals frequently have trouble maintaining wireless phone services under the current plan offerings that require users to pay for services used.

Wireless service providers have attempted to service this sector of the population by providing prepaid wireless service plans. Under these plans, a user receives or purchases a wireless telephone and pays in advance for the wireless service. For example, one user may purchase a wireless telephone and prepay a specified amount, such as fifty dollars, in advance for the wireless service. As the user incurs charges, including charges for roaming, long-distance, and other rates, the charges are deducted from the fifty dollar advance payment. When the user incurs charges totaling the prepaid amount, the wireless service provider discontinues wireless services to that user.

Prepaid wireless services, however, are often not cost effective for the wireless service provider. Generally, when a prepaid wireless subscriber attempts to place or receive a telephone call, the network accesses a database to verify that the prepaid wireless subscriber's account is current and that a balance remains. Many times, the access to the database is maintained during the duration of the telephone call to update the subscriber's account. Accessing the database to verify the account and updating the account is costly and may use resources that could otherwise be used to provide other services. Accordingly, there is a need to provide prepaid wireless services in a cost effective manner.

### SUMMARY OF THE INVENTION

These and other problems are generally solved or circumvented, and technical advantages are generally achieved, by preferred embodiments of the present invention which provides a method and apparatus for providing integrated telephony and Internet services.

In one embodiment of the present invention, a mobile unit comprising memory and a storage medium is provided. The storage medium includes computer program code configured to perform the steps retrieving from memory an available amount of time that the mobile unit is authorized to utilize wireless services with the mobile unit; allowing the mobile unit to utilize wireless services for a first time period, the first time period may be less than or equal to the available amount; and deducting the first time period from the available amount.

In another embodiment of the present invention, a mobile unit comprising memory and a storage medium is provided, wherein the storage medium includes computer program code configured to perform the steps: storing in memory a first amount of flat-rate time units that the mobile unit is pre-authorized to utilize; receiving a first indication that a user is attempting to utilize the mobile unit to connect to a wireless service provider; retrieving the first amount of flat-rate time units from memory; determining whether the first amount of flat-rate time units is above a first limit; and, upon determining the first amount of flat-rate time units is above the first limit, allowing the mobile unit to connect to the wireless service provider.

In yet another embodiment of the present invention, a mobile unit comprising memory and a storage medium is provided, wherein the storage medium includes computer program code configured to perform the steps: retrieving from memory a first amount of flat-rate minutes that the mobile unit is pre-authorized to utilize wireless services; monitoring a first time period that the mobile unit utilizes wireless services; and causing wireless services to be discontinued when the first time period is greater than or equal to the first amount of flat-rate minutes.

In yet still another embodiment, a prepaid application system having a storage medium is provided. The storage medium includes computer program code configured to perform the steps of: receiving an indication that a user of a mobile device has prepaid for a first amount of flat-rate minutes of wireless services; and notifying the mobile unit that the mobile unit is authorized to utilize the first amount of flat-rate minutes of wireless services.

In yet still another embodiment, a prepaid application system having a storage medium is provided, wherein the storage medium includes computer program code configured to perform the steps of: receiving an indication that a mobile unit has utilized a first amount of time of wireless services; determining whether the first amount of time is greater than or equal to a prepaid amount of flat-rate time; and deactivating the mobile unit if the first amount of time is greater than or equal to the prepaid amount of flat-rate time.

In yet still another embodiment, a prepaid application system having a storage medium is provided. The storage medium including computer program code configured to perform the steps of: receiving an indication that a user of a mobile device has prepaid for wireless services; and notifying a plurality of wireless service providers that the mobile device is authorized to utilize the wireless service provider.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof reference is now made to the following descriptions taken in conjunction with the accompanying drawings, in which:

FIG. 1 is a network diagram embodying features of the present invention;

FIG. 2 is a data flow diagram illustrating steps to prepare a mobile unit for use with a wireless prepaid service in accordance with one embodiment of the present invention;

FIG. 3 is a data flow diagram illustrating steps to activate a mobile unit for use with a wireless prepaid service in accordance with one embodiment of the present invention;

FIG. 4 is a data flow diagram illustrating steps to monitor the use of a mobile unit with a wireless prepaid service in accordance with one embodiment of the present invention;

FIG. 5 is a data flow diagram illustrating steps to deactivate a mobile unit for use with a wireless prepaid service in accordance with one embodiment of the present invention;

FIG. 6 is a message flow diagram illustrating steps that may be transmitted during the use of a wireless prepaid service in accordance with one embodiment of the present invention; and

FIG. 7 is a data flow diagram illustrating steps that may be performed to allow a mobile unit to switch wireless service providers in accordance with one embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

It should be noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

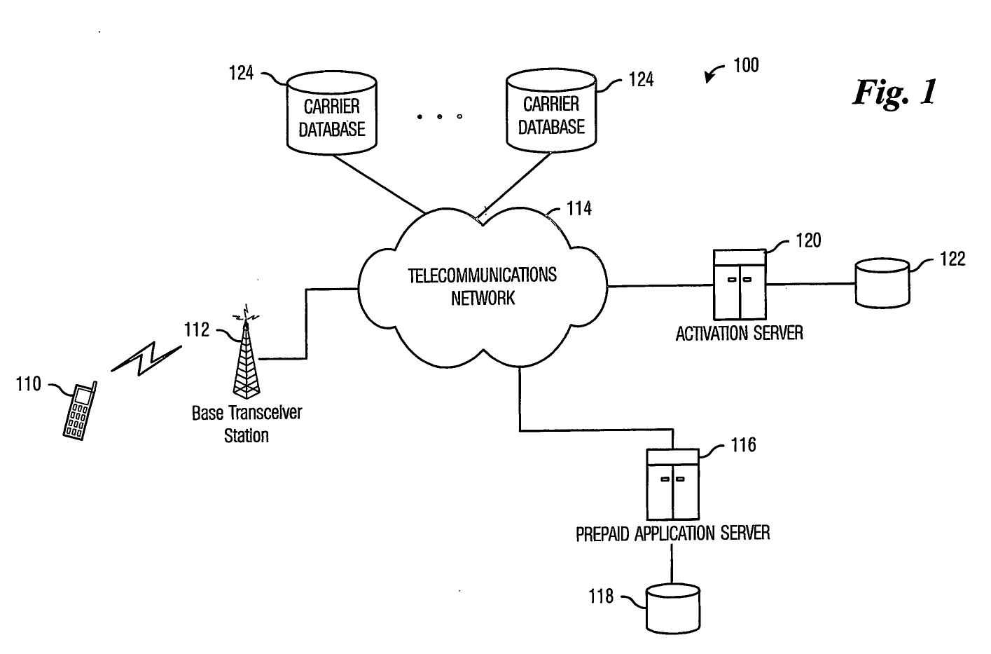

Referring now to FIG. 1, reference numeral 100 designates a network diagram of a portion of a telephony network embodying features of one embodiment of the present invention. It should be noted that one of ordinary skill in the art will realize that the network diagram 100 has been simplified to better illustrate features of the present invention. Well-known elements have not been shown, but are nonetheless part of a telephony network embodying features of the present invention. For example, a network embodying the present invention may include amplifiers, power supplies, maintenance systems, gateways, routers, firewalls, and the like.

The network diagram 100 comprises a mobile unit 110, a base transceiver station (BTS) 112, a telecommunications network 114, a prepaid application server 116, a prepaid application database 118, an activation server 120, an activation database 122, and one or more carrier databases 124.

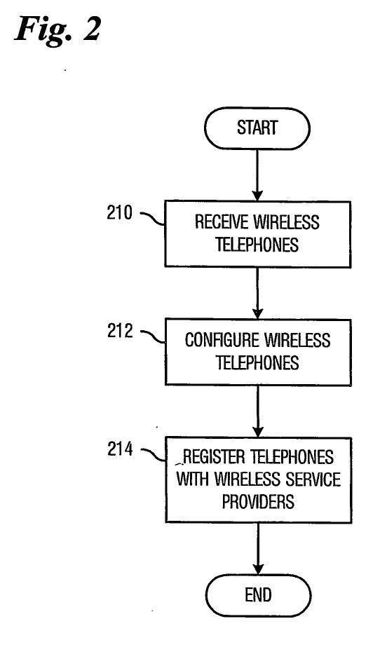

The mobile unit 110 is configured to communicatively couple to the BTS 112, preferably via a wireless communications protocol such as GSM, CDMA, TDMA, GPRS, or the like. In addition, the mobile unit 110 is preferably configured to accept a subscriber identity module (SIM) having a wireless prepaid application stored thereon. The wireless prepaid application is discussed in greater detail below with reference to FIGS. 2-7.

The mobile unit 110 may be, for example, any suitable access device that may be configured to communicate via the telecommunications network 114, such as a wireless phone, laptop computer, desktop computer, tablet personal computer, Personal Data Assistant (PDA), or the like. It is noted that a user (not shown) operates the mobile unit 110. Accordingly, the mobile unit 110 includes a user or an automated system providing input to and receiving output from the mobile unit 110.

The BTS 112 is communicatively coupled to the telecommunications network 114, which may consist of wireline and wireless network elements. The telecommunications network 114 may be, for example, a network such as the Internet, a local-area network (LAN), a wide-area network (WAN), a direct connection, a Public-Switched Telephone Network (PSTN), a wireless communications network, or the like, for providing communications services between users (not shown).

The prepaid application server 116 provides registration and operational management functions for the wireless prepaid service and is communicatively coupled to a prepaid application database 118 that provides storage capabilities. It should be noted that the prepaid application server 116 is illustrated as a single component for illustrative purposes only and may comprise one or more servers or network elements. Furthermore, the prepaid application database 118 may be a stand-alone database system or integrated into the prepaid application server 116. The prepaid application database 118 may comprise an electronic storage medium, such as, for example, a hard disk, tape storage, optical disks, memory, a storage area network (SAN), or the like.

The activation server 120 and the activation database 122 provide mobile unit activation/deactivation capabilities for the wireless prepaid application. Generally, a mobile unit 110 is identified by one or more unique identifiers. In one embodiment, the mobile unit 110 is identified by the combination of International Mobil Equipment Identifier (IMEI), a SIM card identifier, and a phone number. The activation server 120 and the activation database 122 activate the mobile unit 110 so the mobile unit 110 may place and receive telephone calls. The mobile unit 110 may also be deactivated upon some predetermined time or predetermined event, such as use of allocated time or the like.

It should be noted that the activation server 120 and the activation database 122 may be a separate entity, or may be integrated into another network element, such as, for example, the prepaid application server 116 and the prepaid application database 118, respectively. In one embodiment, the activation server 120 and activation database 122 are maintained by a third party. One such third party is GEMPLUS, located in Dallas, Tex., which provides an activation/deactivation interface between the prepaid application server 116 and the carrier databases 124.

The carrier databases 124 represent the wireless service providers' databases of active mobile units, such as mobile unit 110. Generally, each wireless service provider (not shown) only allows mobile units that have been authorized or activated to place or receive telephone calls. Thus, the wireless prepaid application can control the ability of the mobile unit 110 to place or receive calls by modifying (or instructing the wireless service provider to modify) the status of the mobile unit 110 in the appropriate carrier database 124. Likewise, as discussed below, the ability of the mobile unit 110 to use different wireless service provider's networks may be controlled by modifying each wireless service provider's carrier database 124 independently.

The operation and interaction of the wireless prepaid service will be discussed below with reference to FIGS. 2-7.

FIG. 2 is a data flow diagram depicting steps that may be used to configure mobile units, such as mobile unit 110 of FIG. 1, in accordance with one embodiment of the present invention. The process begins in step 210, wherein manufactured mobile units are received, and step 212, wherein the mobile units are configured. Generally, manufacturers produce the mobile units and sell the mobile units in quantity to wholesalers. At this point, the mobile units are not configured for operation, and hence, must be properly configured prior to being used in accordance with the present invention.

Each mobile unit is preferably uniquely identified by one or more identifiers. In one embodiment of the present invention, each mobile unit is uniquely identified by the IMIE and a telephone number. In the preferred embodiment discussed above in which the mobile units are adapted for receiving a SIM card, each mobile unit is further identified by the SIM card number. The configuration process preferably includes identifying a SIM card, an IMIE of a specific mobile unit, and a phone number of a mobile unit as a valid combination.

In step 214, the unique identifier (which may be a single number or a combination of numbers) is registered with the carrier database 124. In one embodiment, the registration process includes registering the unique identifier with the prepaid application server 116 and database 118. The registration of the unique identifier with the prepaid application server 116 allows the wireless prepaid service to manage the minutes of the mobile units, detect fraudulent activities, and provide other customer services.

Furthermore, the registration process described above may utilize an activation service, which provides an interface between the wireless prepaid service provider and the wireless network service provider. In this embodiment, the prepaid application server 116 may notify the activation server 120 of the unique identifier and request that the mobile unit 110 corresponding to the unique identifier be authorized for use with one or more wireless service providers. The activation server 120 preferably stores the activation request information in the activation database 122 and transmits a request to one or more carrier databases 124. Thereafter, the mobile unit is capable of placing and receiving wireless services.

It should be noted that the registration process described above assumes that multiple companies must coordinate their activities in order to provide the wireless prepaid services. For example, the mobile units are provided by a first company, the wireless services are provided by a second company, the wireless prepaid service is administered by a third company, and the activation interface is provided by a fourth company. Under different structures, the basic registration process described above may remain intact, but some steps and network elements may be combined. For example, the prepaid application server 116 may communicate directly with the carrier database 124, thereby eliminating the need for the activation server 120.

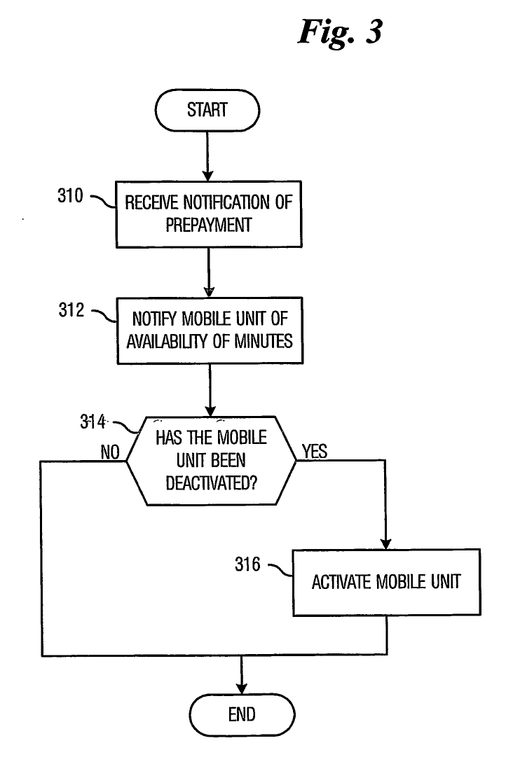

FIG. 3 is a dataflow diagram illustrating steps that may be performed to activate or re-activate a mobile unit 110 after prepayment of a fee in accordance with one embodiment of the present invention. The prepayment of a fee is preferably a specified amount for a specific amount of time units. The time units may be based upon any time period, such as time units, seconds, hours, or the like. In one embodiment, a user prepays for a certain amount of time units. This is typically referred to as a “flat rate plan,” that is the user pays for a number of minutes, regardless of when the use occurs.

The processing begins in step 310, wherein notification of prepayment is received. The user may prepay in a variety of methods. For example, the user may prepay by sending a check to the service provider requesting that the check be applied to the user's account. The user may also call the wireless prepaid service provider and pay by credit/debit card given over the telephone or by a credit/debit card on file. Additionally, and preferably, the user is provided with one or more menus on the mobile unit 110 in which the user may step through to request the service provider to extract payment from a debit/credit card on file.

In one embodiment, the user may purchase the mobile unit 110 from a vendor and dial a predetermined number or sequence. The predetermined number or sequence may be associated with a particular vendor, special, or other marketing program. Once dialed, the user is connected to a customer service representative or an automated system in which the user is able to prepay for services. For example, a user may purchase a mobile unit from a 7-11 convenience store. To activate the service, the user may dial “*711” to prepay for wireless services via a credit/debit card.

After the wireless prepaid service provider has received payment, the mobile unit 110 is notified of the availability of time units as indicated by step 312. As discussed above, it is preferred that the mobile unit 110 track the number of time units available so as not to require the mobile unit 110 to access the telecommunications network 114 and the application server 116 during each use, thereby utilizing additional ports and resources. Thus, it is preferred that the prepaid application server 116 notify the mobile unit 110 of the availability of additional time units. In one embodiment, the prepaid application server 116 notifies the mobile unit 110 of the availability of time via a short-message service (SMS) message.

Next, in step 314, a determination is made whether or not the mobile unit has been deactivated. A mobile unit 110 may be deactivated when the prepaid time units have been utilized by the mobile unit 110, when fraudulent activity has been detected, or the like. If the mobile unit 110 has been deactivated, it is necessary to activate or re-activate the mobile unit 110 such that the mobile unit 110 may utilize the wireless services.

Accordingly, if a determination is made that the mobile unit 110 has been deactivated, then processing proceeds to step 316, wherein the mobile unit 110 is activated. As discussed above, the mobile unit 110 is activated by causing the unique identifier of the mobile unit to be entered in the carrier database 124 to be modified to reflect an active and authorized state of the mobile unit 110.

If a determination is made that the mobile unit 110 is already activated in step 314 or after activation in step 316, the processing terminates.

It should be noted that in an alternative embodiment, a variable rate plan may be utilized. In a variable rate plan, the user prepays a specified amount, but the number of time units paid for may vary dependent upon the time of day the mobile unit is utilized or other factors. In this embodiment, it should be noted that it is preferred that the mobile unit 110, and most preferably the SIM card placed in the mobile unit 110, be configured to administer the variable rate plan. This may be performed by the mobile unit 110 and/or the SIM card, by tracking the dollar amount available and the cost of a call placed at different times of the day.

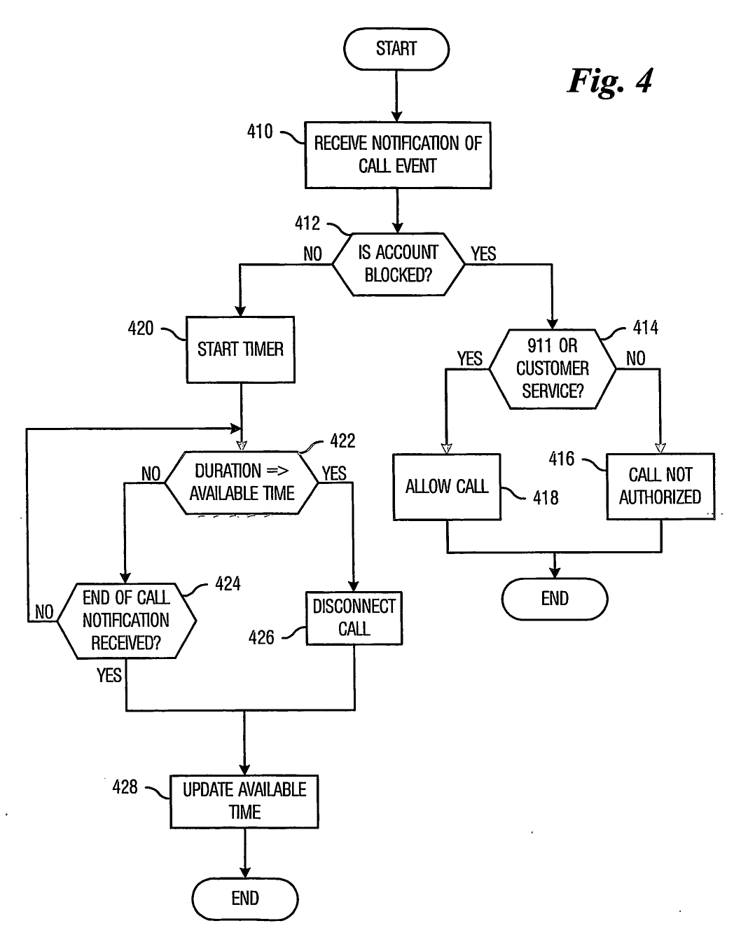

FIG. 4 is a data flow diagram depicting steps that may be performed by a mobile unit 110 to utilize wireless services in accordance with an embodiment of the present invention. Processing begins in step 410, wherein notification is received of a call event. The call event may be, for example, notification of an incoming call, placing an outgoing call, a command received from the user to dial a call or access a service via a wireless service provider (e.g., web-based services), or the like. Upon receipt of the call event, a determination is made in step 412 whether or not the account corresponding to the mobile unit 110 is blocked. In typical situations, the account is blocked if no time units are available for use or if fraudulent activity was detected associated to the mobile unit's account. The account may be blocked in other situations.

It should be noted that the mobile unit 110 may be configured to deduct time units on only select call events. For example, some network configurations utilize a calling party pays (CPP) protocol such that the entity calling a mobile unit 110 pays the wireless fees associated with the mobile unit 110. In these situations, the call event may include the mobile unit 110 placing outgoing calls, but not include the mobile unit 110 receiving incoming calls.

If a determination is made in step 412 that the account is blocked, then processing proceeds to step 414, wherein a determination is made whether or not the user is attempting to utilize the mobile unit 110 to utilize an exempt service. In some situations, it is desirable, or required by law, that the mobile unit 110 be allowed to perform certain activities. For example, it is desirable that the user be allowed to utilize the mobile unit 110 to place emergency calls to 911 emergency services. In addition, it may also be desirable to allow calls to a customer service number, thereby allowing the user to prepay for additional time units. These services are considered exempt services and may be utilized regardless of the status of the user's account. Accordingly, if a determination is made in step 414 that the user was attempting to utilize an exempt service, processing proceeds to step 418, wherein the call is authorized. Otherwise, processing proceeds to step 416 wherein the call is not authorized and, hence, is blocked.

If, in step 412, a determination is made that the account is not blocked, processing proceeds to step 420 wherein a timer is started. The timer is used as a mechanism to allow the mobile unit 110 to monitor the usage and to determine when the mobile unit 110 has utilized the prepaid time units. Thus, after starting the timer, the processing enters a loop represented by steps 422 and 424.

In step 422, a determination is made whether or not the duration of the current call exceeds the maximum allowed duration, which is typically set to the number of time units available for use. If the mobile unit 110 has not utilized available time units, processing proceeds to step 424, wherein a determination is made whether or not an end of call notification has been received. The end of call notification may be generated, for example, by a remote party disconnecting the call, a dropped signal, the user terminating the call, or the like. If the end of call notification has not been received, processing returns to step 422, wherein the duration of the call is compared with the available time units.

If a determination is made in step 422 that the duration of the current call is greater than the available time, then processing proceeds to step 426, wherein the call is disconnected.

In step 428, the available time is updated by subtracting the duration of the call from the available time. Thereafter, processing is completed.

In one embodiment, the depletion of time units may trigger warnings to the subscriber via text messages or an audio tone. The warnings may indicate to the user when predetermined amounts of time remain and, preferably, are given at set intervals. For example, warnings may be given when 10 minutes remain, 5 minutes remain, 4 minutes remain, 3 minutes remain, 2 minutes remain, 1 minute remains, 30 seconds remain, or the like. If audio tones are utilized, the audio tones may be played such that only the user of the mobile unit 110 (and not the entity that the user is communicating with) is able to hear the audio tones.

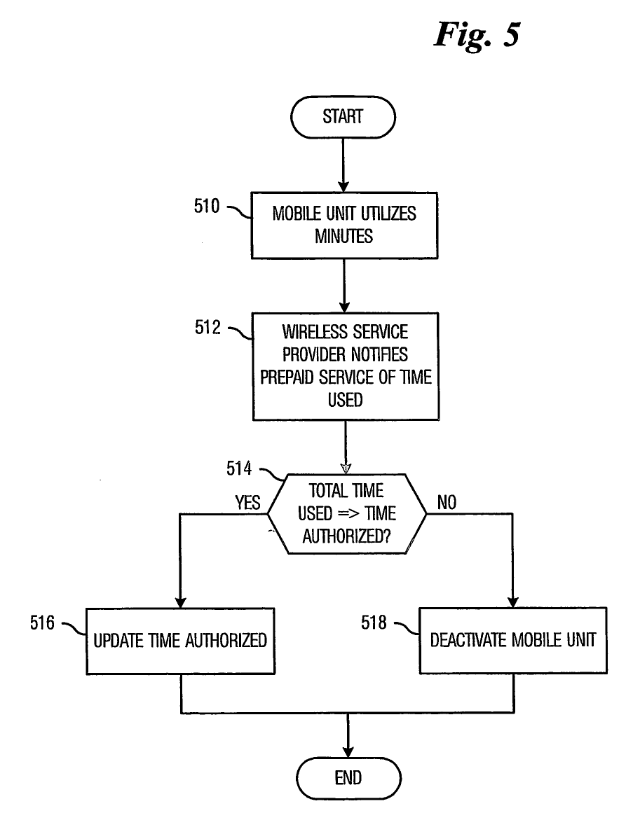

FIG. 5 is a data flow diagram depicting steps that may be performed to monitor the use of the wireless prepaid by a mobile unit in accordance with one embodiment of the present invention. The processing begins in step 510 wherein the mobile unit 110 utilizes time units. One process that may be performed by the mobile unit 110 is described above with reference to FIG. 4.

Upon call completion, the wireless service provider transmits a notification of the duration of the call to the prepaid application server 116, as illustrated in step 512. It should be noted that the notification is a single message that may be transmitted via any suitable communications protocol, including an Ethernet or IP message transmitted via the Internet. Furthermore, because the message is only sent once after call completion, there is no necessity to maintain connections to an application server 116 prior to, during, or after the call.

In step 514, a determination is made, preferably by the prepaid application server 116, whether or not the total time used is greater than or equal to the time authorized or prepaid. The prepaid application server 116 maintains an amount of time units available for each mobile unit 110. If the amount of time units actually used by the mobile unit 110 is less than the amount of time authorized or prepaid, then processing proceeds to step 516, wherein the time authorized is updated. Otherwise, processing proceeds to step 518, wherein the mobile unit 110 is deactivated by causing the database entry corresponding to the mobile unit 110 in the carrier database 124 to be deactivated. By deactivating the entry corresponding to the mobile unit 110 in the carrier database 124, the wireless service provider will not allow the mobile unit 110 to utilize the wireless services;

It should be noted that the embodiments described above maintain the amount of time authorized on the mobile unit 110 and the prepaid application server 116. The mobile unit 110 maintains the time authorized to control the mobile unit's accessibility to wireless services prior to and during a call. The prepaid application server 116, on the other hand, maintains the time authorized after call completion. This dual maintaining of the time authorized allows the maintenance of the time authorized to be handled primarily by the mobile unit 110, while allowing the prepaid application server 116 to identify fraudulent activity. For example, when the mobile unit 110 places a call, the mobile unit 110 monitors the duration of the call and ensures that the duration of the call does not exceed the time authorized. Upon call completion, the prepaid application server 116 receives a message from the wireless service provider indicating the duration of a call. If the duration of the call exceeds the time authorized, then the prepaid application server 116 concludes fraudulent activity and deactivates the mobile unit 110.

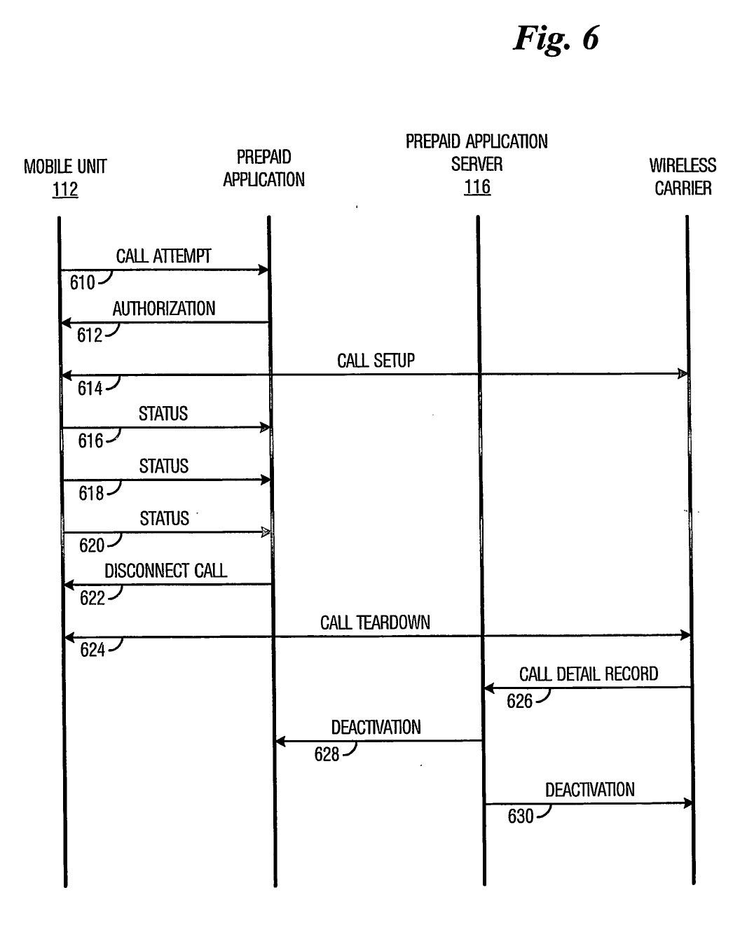

FIG. 6 is a message flow diagram illustrating an interaction between the components of a prepaid wireless service in accordance with one embodiment of the present invention. It should be noted that the messages have been simplified to better illustrate features of the present invention. Accordingly, each message may be decomposed into one or more messages transmitted between one or more components.

Initially, a call attempt message 610 is received from the mobile unit 110 by the prepaid application. It should be noted that the prepaid application in the context of FIG. 6 refers to the prepaid application stored on the mobile unit 110 (or a SIM card in the mobile unit 110). The prepaid application verifies the mobile unit 110 has time authorized and transmits an authorization message to the mobile unit 110.

Thereafter, the mobile unit 110 establishes the call with the wireless carrier. During the call, the mobile unit 110 and the prepaid application monitors the duration of the call and verifies that the duration of the call does not exceed the time authorized, as indicated by messages 616-620. The time period between messages 616-620 may be based upon a fixed time, variable time, an event, or the like. In an embodiment, for example, the status may be checked every 30 seconds.

Message 622 indicates that in response to the status message 620, the prepaid application determined that the call duration exceeded the authorized time, and as a result, the prepaid application has instructed mobile unit 110 to disconnect the call. In response, the mobile unit 110 and the wireless carrier exchange messages to teardown the call.

Upon teardown of the call, the wireless carrier transmits a call detail record to the prepaid application server 116. The call detail record contains, among other things, the duration of the call. The prepaid application server 116 deducts the duration of the call from the authorized time for the mobile unit. Upon detecting that the authorized time has fallen below a predetermined limit, the prepaid application server 116 instructs the prepaid application to deactivate wireless services in message 628 and instructs the wireless carrier to deactivate the mobile unit in message 630.

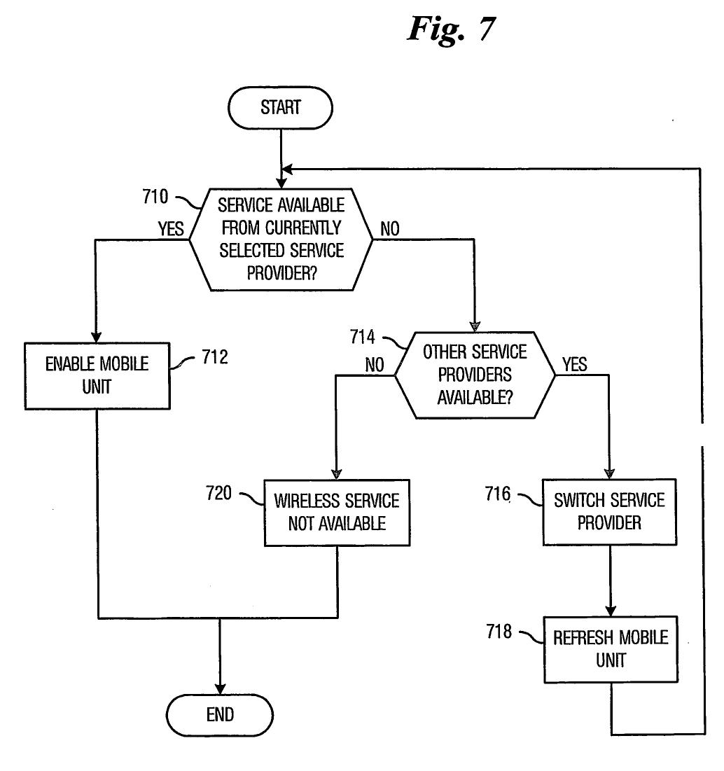

FIG. 7 depicts steps that may be performed by a mobile unit 110 to switch wireless service providers in accordance with one embodiment of the present invention. This feature allows the user to prepay for a specified amount of time units without concern about the wireless service provider. Rather, the wireless prepaid service provider purchases minutes from multiple wireless service providers having overlapping or complementary service areas. As the mobile unit 110 moves from one area to another, the mobile unit 110 may automatically switch wireless service providers. The prepaid time units can be independent of the wireless service provider.

The process begins in step 710, wherein a determination is made whether or not service is available from the currently selected wireless service provider. The currently selected wireless service provider may be initialized to a default wireless service provider or may be initialized to the previously used wireless service provider. In some situations, it may be desirable for the prepaid service provider to assign a default wireless service provider based on promotional programs, to distribute minutes in proportion to minutes purchased from each wireless service provider, or the like.

If a determination is made that service is available from the currently selected wireless service provider, then processing proceeds to step 712, wherein the mobile unit 110 is enabled to allow wireless services.

If, on the other hand, a determination is made that service is unavailable from the currently selected wireless service provider, then processing proceeds to step 714, wherein a determination is made whether or not other service providers are available. If other service providers are not available, then processing proceeds to step 720, wherein the user is notified that wireless service is not currently available.

If a determination is made that other service providers are available, then processing proceeds to step 716, wherein the wireless service provider is switched. In the embodiment in which SIM cards are utilized to control the mobile unit, switching the service provider may be performed by updating the values of the IMSI and Ki files in the SIM card. A REFRESH command may be performed as indicated in step 718 to load the new values into the mobile unit

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A mobile unit comprising memory and a storage medium, wherein the storage medium includes computer program code configured to perform the steps:
retrieving from memory an available amount of time that the mobile unit is authorized to utilize wireless services with the mobile unit;
allowing the mobile unit to utilize wireless services for a first time period, the first time period being less than or equal to the available amount; and
deducting the first time period from the available amount.

2. The mobile unit of claim 1, wherein the storage medium is a subscriber interface module (SIM) card.

3. The mobile unit of claim 1, wherein the memory is a subscriber interface module (SIM) card.

4. The mobile unit of claim 1, wherein the mobile unit utilizes the wireless services via GSM, CDMA, TDMA, or GPRS communications protocol.

5. The mobile unit of claim 1, wherein the computer program code is further configured to receive an indication that a user has prepaid for a second amount of time and adding the second amount of time to the available amount of time.

6. The mobile unit of claim 5, wherein the indication is received via a short message service (SMS) message.

7. The mobile unit of claim 1, wherein the computer program code is further configured to provide a notification to the user when the available amount of time reaches one or more thresholds.

8. The mobile unit of claim 7, wherein the notification comprises an audio tone or a text message.

9. The mobile unit of claim 1, wherein the wireless services include receiving an incoming call.

10. The mobile unit of claim 1, wherein the wireless services include placing an outgoing call.

11. A mobile unit comprising memory and a storage medium, wherein the storage medium includes computer program code configured to perform the steps:
storing in memory a first amount of flat-rate time units that the mobile unit is pre-authorized to utilize;
receiving a first indication that a user is attempting to utilize the mobile unit to connect to a wireless service provider;
retrieving the first amount of flat-rate time units from memory;
determining whether the first amount of flat-rate time units is above a first limit; and
upon determining the first amount of flat-rate time units is above the first limit, allowing the mobile unit to connect to the wireless service provider.

12. The mobile unit of claim 11, wherein the storage medium is a subscriber interface module (SIM) card.

13. The mobile unit of claim 11, wherein the memory is a subscriber interface module (SIM) card.

14. The mobile unit of claim 11, wherein the mobile unit utilizes the wireless services via GSM, CDMA, TDMA, or GPRS communications protocol.

15. The mobile unit of claim 11, wherein the computer program code is further configured to receive a second indication that a user has prepaid for a second amount of time and adding the second amount of time to the first amount of flat-rate units.

16. The mobile unit of claim 15, wherein the second indication is received via a short message service (SMS) message.

17. The mobile unit of claim 11, wherein the computer program code is further configured to provide a notification to the user when the available amount of time reaches one or more thresholds.

18. The mobile unit of claim 17, wherein the notification comprises an audio tone or a text message.

19. The mobile unit of claim 11, wherein the wireless services include receiving an incoming call.

20. The mobile unit of claim 11, wherein the wireless services include placing an outgoing call.

21. A mobile unit comprising memory and a storage medium, wherein the storage medium includes computer program code configured to perform the steps:
retrieving from memory a first amount of flat-rate minutes that the mobile unit is pre-authorized to utilize wireless services;
monitoring a first time period that the mobile unit utilizes wireless services; and
causing wireless services to be discontinued when the first time period is greater than or equal to the first amount of flat-rate minutes.

22. The mobile unit of claim 21, wherein the storage medium is a subscriber interface module (SIM) card.

23. The mobile unit of claim 21, wherein the memory is a subscriber interface module (SIM) card.

24. The mobile unit of claim 21, wherein the mobile unit utilizes the wireless services via GSM, CDMA, TDMA, or GPRS communications protocol.

25. The mobile unit of claim 21, wherein the computer program code is further configured to receive a second indication that a user has prepaid for a second amount of time and adding the second amount of time to the first amount of flat-rate units.

26. The mobile unit of claim 25, wherein the second indication is received via a short message service (SMS) message.

27. The mobile unit of claim 21, wherein the computer program code is further configured to provide a notification to the user when the available amount of time reaches one or more thresholds.

28. The mobile unit of claim 27, wherein the notification comprises an audio tone or a text message.

29. A prepaid application system having a storage medium, the storage medium including computer program code configured to perform the steps of:
receiving an indication that a user of a mobile device has prepaid for a first amount of flat-rate minutes of wireless services; and
notifying the mobile unit that the mobile unit is authorized to utilize the first amount of flat-rate minutes of wireless services.

30. The prepaid application system of claim 29, wherein the step of notifying is performed by transmitting a short message service (SMS) message to the mobile unit.

31. A prepaid application system having a storage medium, the storage medium including computer program code configured to perform the steps of:
receiving an indication that a mobile unit has utilized a first amount of time of wireless services;
determining whether the first amount of time is greater than or equal to a prepaid amount of flat-rate time; and
deactivating the mobile unit if the first amount of time is greater than or equal to the prepaid amount of flat-rate time.

32. A prepaid application system having a storage medium, the storage medium including computer program code configured to perform the steps of:
receiving an indication that a user of a mobile device has prepaid for wireless services; and
notifying a plurality of wireless service providers that the mobile device is authorized to utilize the wireless service provider.
